(19) United States
(12) Patent Application Publication
(10) Pub. No.: US 2026/0258248 A1
(43) Pub. Date: Sep. 3, 2026

(54) SOLUTION OF POLYARYLSULFONE POLYMERS IN N-(2'-HYDROXYETHYL)-2-PYRROLIDONE FOR MEMBRANE PREPARATION AND USE

(71) Applicant: BASF SE, Ludwigshafen am Rhein (DE)

(72) Inventors: Oliver GRONWALD, Ludwigshafen am Rhein (DE); Simon POULTON, Ludwigshafen am Rhein (DE); Torben ADERMANN, Ludwigshafen am Rhein (DE)

(21) Appl. No.: 18/878,686

(22) PCT Filed: Jun. 19, 2023
(86) PCT No.: PCT/EP2023/066372

§ 371 Date: Dec. 24, 2024

(30) Foreign Application Priority Data
Jun. 29, 2022 (EP) 22181728.1

(51) Int. Cl. C08L 81/06; B01D 67/00; B01D 71/68; C08G 75/23; C08K 5/3415

(52) U.S. Cl. CPC C08L 81/06; B01D 67/0013; B01D 67/0016; B01D 71/68; C08G 75/23; C08K 5/3415

(57) ABSTRACT

The present invention relates to a solution comprising a polyarylsulfone polymer selected from the group of polyethersulfone and polysulfone and N-(2′-hydroxyethyl)-2-pyrrolidone, the process of making a membrane thereof and the use of this membrane for separation processes.

The present invention relates to a solution comprising a polyarylsulfone polymer selected from the group of polyethersulfone and polysulfone and N-(2′-hydroxyethyl)-2-pyrrolidone, the process of making a membrane thereof and the use of this membrane for separation processes.

Polyarylsulfone polymers, such as polysulfones (i.a. merchandized under the trade names: Ultrason® S, Udel®) and polyethersulfones (i.a. merchandized under the trade names: Ultrason® E, Veradel®, Sumicaexel®) are high performance polymers which are used in a variety of technical applications because of their mechanical properties and their chemical and thermal stability. One major technical application of polyarylsulfone polymers is their usage as raw materials for the production of polymer membranes, for example, dialysis or ultrafiltration membranes. Polymer membranes are used in separation processes and are widely applied, e.g., in medical applications, the food technology, biotechnology, pharmaceutical industries, and water treatment.

In J. G. Wijmans et. al., Eur. Polym. J., 1983, Vol. 19, No. 12, pp. 1143-1146 it is pointed out that polyarylsulfone polymers have a limited solubility in many common solvents. Especially concentrated solutions of polysulfone in various solvents tend to become turbid and sedimentation occurs.

WO 2019042749 A1 discloses a process for making a membrane by bringing a polymer solution comprising a polymer, a first solvent, and a co-solvent in contact with a coagulating agent. As first solvent N-methylpyrrolidone and N-ethylpyrrolidone is claimed. Polyvinylpyrrolidone is used as a water-soluble polymer. Furthermore, a membrane obtained by this process is disclosed. The workup of the membrane includes an oxidizing step with sodium hypochlorite. The manufacturing of membranes from a polymer solution is furthermore described in WO 2015056145 A1.

WO 2017220386 A1 discloses the use of a solution of polysulfone in N-acyl-morpholine for the fabrication of ultrafiltration membranes. As water-soluble polymer, polyvinylpyrrolidone is used.

Without that added water-soluble polymer, the obtained membranes have no water permeability. Work-up of the membranes includes an oxidizing step using sodium hypochlorite.

WO 2021191043 describes the use of N-n-butyl-2-pyrrolidone as alternative solvent for different polymer classes, including polyarylsulfone polymers. The use of such solutions in combination with a water-soluble polymer in membrane fabrication is also described. Different polyvinylpyrrolidone grades are used as water-soluble polymers. The work-up of the membranes include an oxidizing step using sodium hypochlorite.

PCT/EP2021/082449 describes a solution comprising at least one sulfone polymer and N-tert.butyl-2-pyrrolidone as alternative solvent. The use of such solutions in combination with a water-soluble polymer in membrane fabrication is also described. A combination of different grades of polyvinylpyrrolidone are used as water-soluble polymer. Work-up of the membrane includes an oxidizing step using sodium hypochlorite.

In the above mentioned state of the art an additional oxidizing step using, e.g., sodium hypochlorite, is needed during the work-up of the membrane.

In S. Munari et. al., Desalination, 1988, Vol. 70, pp. 265-275, the preparation of microporous polysulfone membranes from casting solutions of polysulfone, solvent and polyvinylpyrrolidone as additive is described. N, N-dimethylacetamide, N,N-dimethylformamide, dimethylsulfoxide, and N-methyl-2-pyrrolidone are mentioned as common solvents. It is pointed out, that due to the low molecular mass of the polymer, polysulfone solutions are characterized by low viscosities and consequently, are difficult to cast. To overcome this problem it has become common practice to add high molecular weight polyvinylpyrrolidones to the polysulfone solutions. In the experiments, N,N-dimethylacetamide is used as solvent, which is classified in the European Union as a chemical of very high concern. Work-up of the membrane consists of washing with water.

US 2005/0170183 A1 describes a molded body at the surface of which substituents characterized by different formulae are bound. The molded bodies contain polyarylethers, which can be, beside others, polyarylsulfone polymers (e.g., polyethersulfones). The preparation of molded bodies in form of membranes or films is described, e.g., from solutions of polyethersulfones in N, N-dimethylacetamide or dimethyl sulfoxide. For membrane production, furthermore the use of poly(ethylene glycol) in the solution is mentioned.

The functionalization of the readily prepared molded body (film or membrane) is performed by treatment of the molded body in a heterogeneous reaction with aq. H₂SO₄ containing an agent and a carbonyl compound. Beside others, as an example for the agent, N-(2′-hydroxyethyl)-2-pyrrolidone is mentioned, i.e., N-(2′-hydroxyethyl)-2-pyrrolidone is not used as a solvent but as a reagent to modify the non-dissolved molded body.

EP 3756753 A1 discloses a combination of pyrrolidone-based solvents for the production of membranes as alternative to the conventionally used solvents. The combination comprises 2-pyrrolidone and N-alkyl-2-pyrrolidone, especially N-n-butyl-2-pyrrolidone. As membrane forming polymers, polyarylsulfone polymers are described, which are used in combination with water-soluble polymers, the latter being a mixture of polyvinylpyrrolidone and poly(ethylene glycol).

In C. Kahrs et. al., Polymer 2020, Vol. 186, 122071, the membrane formation via nonsolvent induced phase separation using different solvents is described. N-methylpyrrolidone and

N,N-dimethylacetamide as conventional solvents are compared to 2-pyrrolidone and N,N-dimethyllactamide as alternative solvents. In all four solvent systems, varying concentrations and molecular weights of polyvinylpyrrolidone and poly(ethylene glycol) are applied. The viscosity of the polymer solutions as well as the membrane characteristics are discussed.

In general, there is an ongoing demand for solvents which are suitable to replace the currently used solvents in specific applications. One demand is a less problematic toxicological profile compared to the conventionally used solvents, like N-methyl-2-pyrrolidone. With respect to sulfone polymer solutions, the solvents should furthermore enable solutions with high sulfone polymer content without turbidity. Also, solutions further containing water-soluble polymers should be stable and clear, since these factors influence the pore structure and thus the quality of the membranes obtained from these solutions. Since the solvents conventionally used for membrane fabrication result in low viscous polymer solutions, which are difficult to cast, there is also the demand for solvent systems leading to polymer solutions with higher viscosity.

Furthermore, it is required, that the solvents utilized for membrane production by nonsolvent induced phase inversion show complete miscibility with water which is used as coagulant. Regarding membranes obtained by using these polymer solutions, it is important, that at least the same standard of membrane quality and possibly an even better membrane quality is achieved. In particular, the water permeability of such membranes should be as high as possible combined with few defects or macrovoids visible in the cross-section of the membrane.

A further requirement is an acceptable mechanical stability and thus a long lifetime of the membranes.

It was an object of the present invention to find an easily accessible and obtainable solvent of low toxicological concern which dissolves polyarylsulfone polymers leading to solutions of low turbidity and high viscosity, and therefore allows for a straightforward preparation of membranes. It was a further object of the present invention to provide a process for the preparation of membranes based on these solutions being as simple as possible, e.g., by avoiding tedious and/or hazardous work-up of the membranes. It was a further object of the invention to provide membranes showing an improved membrane performance.

We have surprisingly found that the above mentioned object can be achieved by a solution comprising
(a) a polyarylsulfone polymer selected from the group of polyethersulfone comprising repeating units of formula I

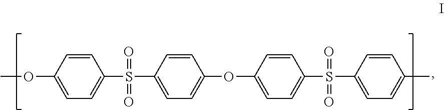

and polysulfone comprising repeating units of formula II

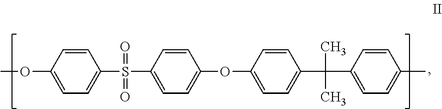

or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer,
and
(b) N-(2′-hydroxyethyl)-2-pyrrolidone.

### Polyarylsulfone Polymer

The polyarylsulfone polymer comprises at least 95 wt.-% (% per weight), preferably at least 97 wt.-%, more preferably at least 98 wt.-%, and particularly preferably at least 99 wt.-% of the repeating units of formula I and II based on the total weight of the polyarylsulfone polymer.

The polyarylsulfone polymer is a polymer comprising —S(═O)₂— units in the polymer. —S(═O)₂— units are also designated as sulfonyl units.

The polyarylsulfone polymer comprises aromatic groups. Beside 1,4-phenylene units, the polyarylsulfone polymer can also comprise units based on minor isomers, like 1,2-phenylene oder 1,3-phenylene units.

The polyarylsulfone polymer comprises endgroups at the polymer chain ends, like Cl—, OH—, MeO—, tert.butyl-, or arylgroups. The different chain ends may comprise different endgroups. The polyarylsulfone polymer usually comprises 0.02 to 1 wt.-% (% by weight) endgroups, preferably 0.03 to 0.8 wt.-% based on the total weight of the polyarylsulfone polymer.

The polyarylsulfone polymer comprises<5 wt.-% further chemical groups, which are not represented by the repeating units of formula I and II, preferably <3 wt.-%, more preferably <2 wt.-%, and particularly preferably <1 wt.-% based on the total weight of the polyarylsulfone polymer. These further chemical groups typically are endgroups or minor aromatic isomers as described above.

As examples for polyethersulfone polymers comprising the repeating unit of formula I Ultrason® E grades available from BASF SE, like Ultrason® E 2020 P, Ultrason® E 3010, Ultrason® E 6020 P or Ultrason® E 7020 P are mentioned.

As examples for polysulfone polymers comprising the repeating unit of formula II Ultrason® S grades available from BASF SE, like Ultrason® S 3010 or Ultrason® S 6010 are mentioned.

The weight average molecular weight M_{w} of a polymer is based on the summarized mass of molecules having a certain molecular mass. To this value, larger, i.e. higher mass molecules have a larger contribution than smaller, i.e. lower mass molecules. M_{w} and its determination are well known in the art. M_{w} can be, for example, determined by gel permeation chromatography (GPC), using a suitable column (stationary phase), solvent (liquid phase), and detector (e.g., via refractive index or UV). These chromatography units have to be calibrated using standard polymers of known molecular weight (e.g., polystyrene). Considering the detector's signal and the calibration curve, attached computer systems calculate the chromatogram which represents the molecular weight distribution of the respective sample. The molecular weight distribution describes the number of molecules present in a sample versus their molar mass. M_{w} and the number average molecular weight Mₙ are received via computational analysis. Mₙ is based on the number of molecules bearing a specific mass. Using these two values, also the polydispersity index (PDI=M_{w}/Mₙ) can be calculated which is a measure for the broadness of the molecular weight distribution.

The polyarylsulfone polymers show weight-average molecular weight values M_{w} of 40000 to 105000 g/mol, preferably 45000 to 100000 g/mol, and more preferably 50000 to 95000 g/mol as determined via gel permeation chromatography (GPC) in tetrahydrofuran (THF) and polystyrene (PS) as standard. The preferred polyethersulfone polymers comprising the repeating unit of formula I show weight-average molecular weight values of 40000 to 100000 g/mol, preferably 48000 to 90000 g/mol and the preferred polysulfone polymers comprising the repeating unit of formula II show weight-average molecular weight values of 45000 to 70000 g/mol, preferably 53000 to 60000 g/mol as determined via GPC in THF and PS as standard.

The preferred polyarylsulfone polymers show polydispersity indices of 2 to 5, preferably 2.5 to 4.7. The preferred polyethersulfone polymers comprising the repeating unit of formula I show PDI-values of 2.5 to 3.6, preferably 2.7 to 3.4 and the preferred polysulfone polymers comprising the repeating unit of formula II show PDI-values of 3.8 to 4.7, preferably 4 to 4.5. The glass transition temperature T_{g} is the temperature region at which polymer chain segments become mobile and the sample undergoes a reversible transition from solid, amorphous regions to a softer state of higher flexibility. The glass transition temperature and its determination is well known in the art. It can be determined for example by differential scanning calorimetry (DSC), measuring the heat capacity versus the temperature, whereby the temperature is changed at constant speed (e.g., 10 K/min). Usually, the sample is first cooled and then heated with the same speed. The glass transition temperature can be received from the resulting diagram by geometrical or computational analysis.

The preferred polyarylsulfone polymers show glass transition temperatures of 160 to 250° C., preferably 170 to 240° C., and more preferably from 180 to 230° C., measured via differential scanning calorimetry (DSC) according to ISO 11357-1 (2017) and 11357-2 (2020) at a heating rate of 10 K/min.

The viscosity number (reduced viscosity, VN) correlates with the molecular weight of the polymer and can be measured based on ISO 1628-5 (1998) in a 1 wt.-% polymer solution in N-methylpyrrolidone. Thereby, the elution time (t) of a defined volume of the polymer solution in an Ubbelohde 1C-capillary is related to the running time of the pure solvent (to) and normalized afterwards with the polymer concentration (c in g/ml) according to equation 1:

$$V N = ( \frac{t}{{t}_{0}} - 1 ) \times \frac{1}{c} \qquad ( 1 )$$

The viscosity number is given in ml/g. The preferred polyarylsulfone polymers show viscosity numbers of 40 to 130 ml/g, preferably 50 to 120 ml/g, and most preferably of 60 to 110 ml/g, based on ISO 1628-5 (1998) in a 1 wt.-% polymer solution in N-methylpyrrolidone.

### Solvent

The inventive solution comprises N-(2′-hydroxyethyl)-2-pyrrolidone (CAS-No. 3445-11-2) as solvent, which is commercially available in industrial scale. This solvent is a protic solvent and of low toxicological concern in contrast to various frequently used aprotic pyrrolidone derivatives, such as N-methyl-2-pyrrolidone, which is classified as “May damage fertility. May damage the unborn child.” according to the GHS hazard statements (Globally Harmonized System of Classification and Labelling of Chemicals). Polyarylsulfone polymers and mixtures of polyarylsulfone polymers with water-soluble polymers can be well dissolved by N-(2′-hydroxyethyl)-2-pyrrolidone leading to clear solutions showing surprisingly high viscosities. Both, clarity and a minimum viscosity are requirements for the preparation of high-quality membranes from such solutions.

### Solution

The inventive solution comprises preferably 50-99 wt.-% of N-(2′-hydroxyethyl)-2-pyrrolidone, more preferably 55-95 wt.-%, particularly preferably 60-90 wt.-%, very particularly preferably 65-85 wt.-%, and most preferably 70-80 wt.-% based on the total weight of the solution. The inventive solution comprises 1 to 50 wt.-%, preferably 5 to 45 wt.-%, more preferably 7 to 40 wt.-%, particularly preferably 10 to 35 wt.-%, and very particularly preferably 12 to 25 wt.-% polyarylsulfone polymer based on the total weight of the solution.

### Water-Soluble Polymers

The inventive solution may further comprise a water-soluble polymer, i.e., a polymer that can be readily dissolved in water to give a clear solution in concentrations of at least 10 g polymer per 100 g water at 21° C. These water-soluble polymers influence the solution viscosity and therefore act as viscosity modifiers. Furthermore, these water-soluble polymers act as pore forming agent in the process of membrane preparation and therefore strongly influence the membrane characteristics. Usually, the water-soluble polymers filling the formed pores are removed in a work-up step of membrane preparation. This step can comprise different washing and/or oxidizing steps to remove the water-soluble polymers, which, after removal, leave the empty pores. Beside other parameters, polymer type and molecular weight strongly influence the effort necessary for removal of the water-soluble polymers during the work-up of the membrane.

Preferably, the water-soluble polymer is selected from the group of polyvinylpyrrolidone and poly(alkylene oxide) s or mixtures thereof usually showing a number average molar mass Mₙ of at least 250 g/mol. More preferably, the water-soluble polymer is selected from the group of polyvinylpyrrolidone, poly(ethylene oxide), poly(propylene oxide), and poly(ethylene oxide)/poly(propylene oxide)-block-copolymers or mixtures thereof showing a Mₙ of at least 250 g/mol. Particularly preferably, the water-soluble polymer is selected from the group of polyvinylpyrrolidone and poly(ethylene oxide) or mixtures thereof with Mₙ of at least 250 g/mol and, in the case of polyvinylpyrrolidone with a solution viscosity characterized by the K-value of 12 or higher determined according to the method of Fikentscher described by Fikentscher in Cellulosechemie 13, 1932 (58). The K-value is determined by viscosity measurements of polymer solutions as described by Fikentscher and is known in the art. A very particularly preferred water-soluble polymer is a polyvinylpyrrolidone with Mₙ of at least 250 g/mol and a solution viscosity characterized by the K-value of 12 or higher determined according to the method of Fikentscher described by Fikentscher in Cellulosechemie 13, 1932 (58).

Preferably, the solution comprises 0.1 to 15 wt.-% of water-soluble polymer, more preferably 2 to 10 wt.-%, and particularly preferably 3 to 7 wt.-% based on the total weight of the solution. More preferably, the solution comprises 0.1 to 15 wt.-% of water-soluble polymer selected from the group of water-soluble polyvinylpyrrolidone and water-soluble poly(alkylene oxide) s or mixtures thereof, preferably 2 to 10 wt.-%, and more preferably 3 to 7 wt.-% based on the total weight of the solution.

Particularly preferably, the solution comprises 0.1 to 15 wt.-% of water-soluble polymer selected from the group of water-soluble polyvinylpyrrolidone, water-soluble poly(ethylene oxide), water-soluble poly(propylene oxide), and water-soluble poly(ethylene oxide)/poly(propylene oxide)-block-copolymers or mixtures thereof, preferably 2 to 10 wt.-%, and more preferably 3 to 7 wt.-% based on the total weight of the solution.

Very Particularly preferably, the solution comprises 0.1 to 15 wt.-% of water-soluble polymer selected from the group of water-soluble polyvinylpyrrolidone and water-soluble poly(ethylene oxide) or mixtures thereof, preferably 2 to 10 wt.-%, and more preferably 3 to 7 wt.-% based on the total weight of the solution.

Most preferably, the solution comprises 0.1 to 15 wt.-% of water-soluble polyvinylpyrrolidone, preferably 2 to 10 wt.-%, and more preferably 3 to 7 wt.-% based on the total weight of the solution.

### Additives

The inventive solution may further comprise an additive, i.e., one or more additives or mixtures thereof. Additives are compounds, which dissolve the polyarylsulfone polymer selected from the group of polyethersulfone comprising repeating units of formula I and polysulfone polymer comprising repeating units of formula II or mixtures thereof only at low concentrations of <1 g polyarylsulfone polymer per 100 g additive at 21° C. In the process of membrane preparation, additives influence the velocity of solvent exchange and thus of the precipitation process and therefore control membrane properties like pore size and number.

Preferably, the additive is selected from the group of water, C₁-C₄ alkanols, C₂-C₈ alkanediols, oligo (alkylene glycol) s, and C₃-C₁₂ alkanetriols or mixtures thereof. More preferred additives are methanol, ethanol, propanol, isopropanol, n-butanol, iso-butanol, sec-butanol, tert-butanol, ethylene glycol, di(ethylene glycol), tri (ethylene glycol), tetra(ethylene glycol), propane-1,2-diol, di(propylene glycol), tri (propylene glycol), tetra(propylene glycol), propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, heptane-1,7-diol, octane-1,8-diol, octane-1,2-diol, hexa-1,5-diene-3,4-diol, neopentyl glycol, 2-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, glycerol, butane-1,2,3-triol, butane-1,2,4-triol, pentane-1,2,3-triol, pentane-1,2,4-triol, pentane-1,2,5-triol, hexane-1,2,3-triol, hexane-1,2,4-triol, hexane-1,2,6-triol, hexane-1,3,4-triol, hexane-1,3,5-triol, hexane-1,3,6-triol, hexane-1,4,5-triol, trimethylolmethane, 1,1,1-trimethylolethane, 1,1,1-trimethylolpropane or mixtures thereof.

Preferably, the solution comprises 0.1 to 20 wt.-%, more preferably 1 to 15 wt.-%, particularly preferably 2 to 13 wt.-% and very particularly preferably 5 to 12 wt.-% of the additive based on the total weight of the solution.

### Cosolvents

Beside N-(2′-hydroxyethyl)-2-pyrrolidone, the inventive solution may comprise further solvents herein designated as cosolvents. In the process of membrane preparation, cosolvents influence the velocity of solvent exchange and thus of the precipitation process and therefore control membrane properties like pore size and number.

Preferred cosolvents are solvents that are readily miscible with N-(2′-hydroxyethyl)-2-pyrrolidone at any ratio. More preferred suitable cosolvents are, for example, selected from high-boiling ethers, esters, ketones, asymmetrically halogenated hydrocarbons, anisole, gamma-valerolactone, N,N-dimethylformamide, dimethylsulfoxide, dihydrolevoglucosenone, methyl-5-(dimethylamino)-2-methyl-5-oxopentanoate, sulfolane, N-methyl-2-pyrrolidone, N-ethyl-2-pyrrolidone, N-n-butyl-2-pyrrolidone, N-tert-butyl-2-pyrrolidone, N,N-dimethyl-2-hydroxypropanoic amide, and N, N-diethyl-2-hydroxypropanoic amide. Particularly preferred cosolvents are gamma-valerolactone, N-tert-butyl-2-pyrrolidone, and N-n-butyl-2-pyrrolidone.

In a preferred embodiment, at least 10 wt.-%, more preferably at least 50 wt.-%, particularly preferably at least 80 wt.-%, and very particularly preferably at least 90 wt.-% of the total weight amount of all solvents of the solution is N-(2′-hydroxyethyl)-2-pyrrolidone. In a more preferred embodiment, no cosolvent is used in the solution and N-(2′-hydroxyethyl)-2-pyrrolidone is the only solvent used.

### Preparation of the Solution

The solution of the invention can be easily prepared by combining the different components of the solution. In general, there is no specific order in which the different components are to be added. Therefore, the solution of the invention can be prepared by combining all the components, i.e. polyarylsulfone polymer, N-(2′-hydroxyethyl)-2-pyrrolidone, and if need be, further components like water-soluble polymer, additives, or cosolvents, and dissolving all compounds according to any process known in the art

The solution process may, for example, advantageously be supported or accelerated by increasing the temperature of the mixture and/or by mechanical operations like stirring, shaking, subjection to ultrasound (e.g. by using an ultrasonification bath) etc.

In a preferred embodiment under stirring at 60° C., first the polyarylsulfone is dissolved in N-(2′-hydroxyethyl)-2-pyrrolidone and subsequently, the water-soluble polymer and additives are added and stirred until a clear solution is received.

The inventive solution usually shows a viscosity of 0.1 to 150 Pa·s, preferably 0.5 to 75 Pa·s, particularly preferably 1 to 50 Pa·s, and most preferably of 2 to 30 Pa·s as determined with a Brookfield Viscometer DV-I Prime from Brookfield Engineering Laboratories, Inc. Middleboro, USA) with RV 6 spindle at 60° C. with 5-100 rpm (rounds per minute). The shear rate, i.e., rounds per minute, is usually selected depending on the viscosity of the sample. Typically, low viscous samples are measured at higher shear rates, whereas higher viscous samples are measured at lower shear rates.

High solution viscosities, as shown by the inventive solutions, are beneficial for the casting process during membrane preparation by leading to better film quality. Furthermore, in case of high solution viscosities, during membrane preparation there is generally no need to use high molecular weight water-soluble polymers to (further) increase the viscosity.

A measure for turbidity is the nephelometric turbidity unit (NTU) determined with a calibrated nephelometer or turbidimeter, expressing the amount of light reaching a detector at the side of a light beam after being scattered of the sample. Preferably, the inventive solution shows a turbidity of 0 to 2 NTU, more preferably of 0 to 1 NTU, particularly preferably of 0 to 0.9 NTU as determined with a turbidimeter 2100 AN (Hach Lange GmbH, Düsseldorf, Germany) employing a filter of 860 nm at 60° C.

A low solution turbidity is a prerequisite for the preparation of high quality films and thus, high performance membranes, because hereby macrovoids and defects in the membranes are avoided which would affect the balance between pure water permeability and molecular weight cut-off.

### Preparation of the Membrane

We have further found a process for preparing a membrane using a solution comprising
(a) a polyarylsulfone polymer selected from the group of polyethersulfone comprising the repeating unit of formula I and polysulfone comprising the repeating unit of formula II or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer,
(b) N-(2′-hydroxyethyl)-2-pyrrolidone, and
(c) a water-soluble polymer.

In the context of this application, a membrane shall be understood to be a semipermeable structure capable of separating two fluids or separating molecular and/or ionic components or particles from a liquid. A membrane acts as a selective barrier, allowing some particles, substances or chemicals to pass through, while retaining others. The membrane may have various geometries such as flat sheet, spiral wound, pillows, tubular, single bore hollow fiber or multiple bore hollow fiber.

Separation by using membranes can be operated in different ways, e.g., driven by pressure, by concentration gradients or by gradients like electric potential or temperature gradients. Examples for pressure driven operations are micro-, ultra- or nanofiltration or reverse osmosis operations. Examples for concentration-based operations are dialysis or forward osmosis. A good overview is given in WO 2017/045985 or in M. Ulbricht, Polymer 47 (2006), pp. 2217-2262 which are herewith incorporated herein by reference. A preferred membrane is the ultrafiltration membrane.

Membranes can be prepared by different methods, like phase separation (phase inversion) of polymers, sol-gel process, interface reaction, stretching, extrusion, track-etching, micro-fabrication, etc.

Preferably, the membranes according to the invention are prepared by liquid nonsolvent-induced phase separation (NIPS), which comprises the following steps:
a) Preparing a solution comprising a polyarylsulfone polymer selected from the group of polyethersulfone comprising the repeating unit of formula I and polysulfone comprising the repeating unit of formula II or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer, N-(2′-hydroxyethyl)-2-pyrrolidone, and a water-soluble polymer.
b1) Shaping the polymer solution into a certain geometry, like, for example, fiber, tubular or flat sheet geometries, by methods like, for example, extrusion of the polymer solution or preparation of a film from or casting the polymer solution.
b2) Solidifying the geometry shaped in Step b1) by exposing the polymer solution to a coagulant.

### Step a)

The solution of step a) corresponds to a polymer solution as described above. Preferably, the solution further contains additives and/or cosolvents as described above. The preparation of the solution of step a) can be performed as described above.

In a preferred embodiment, the solution of step a) comprises 5 to 45 wt.-% of the polyarylsulfone polymer, 55 to 95 wt.-% of N-(2′-hydroxyethyl)-2-pyrrolidone, and 1 to 15 wt.-% of water-soluble polymer based on the total weight of the solution.

In a more preferred embodiment, the solution of step a) comprises 10 to 35 wt.-% of the polyarylsulfone polymer, 60 to 90 wt.-% of N-(2′-hydroxyethyl)-2-pyrrolidone, and 2 to 10 wt.-% of water-soluble polymer based on the total weight of the solution.

In one embodiment, the solution may be degassed and/or heated before proceeding to the next step.

### Step b1) and b2)

Steps b1) and b2) can either be performed continuously, i.e. not as separated steps, for example, in case of the continuous extrusion of the polymer solution into a coagulation bath, or in separated steps, for example first forming a polymer film, which is then transferred to a coagulation bath after a certain drying time.

The shaped polymer solution still contains the polyarylsulfone polymer, the solvent, the water-soluble polymers etc. The phase separation of polymer and solvent has not started or is not yet completed, i.e. the polymer is not yet completely solidified. In case of form shaping by extrusion, the polymer solution is brought into a fiber- or tubular-shaped geometry. In case of form shaping by film generation or casting, the polymer solution is brought into a flat sheet geometry.

The exposition of the shaped polymer solution to the coagulant (step b2) can, for example, take place in a coagulation bath containing a coagulant. The polyarylsulfone polymer should have a low solubility in the coagulant, i.e. <1 g polyarylsulfone polymer per 100 g of coagulant at 21° C.

The contact to the coagulant induces the nonsolvent-induced de-mixing of the homogeneous polymer solution, which results in the solidification of the polymer and thus the membrane formation in the respective geometry of the shape of the polymer solution. The membrane structure and morphology is strongly dependent on the process parameters used hereby, as well as on the nature and presence of the different chemical compounds present in the solution. The water-soluble polymer and the additives have mainly two functions: on the one hand side they adjust the solution viscosity on a high level which makes film formation, e.g., by casting easier, on the other side they function as pore formation agents, strongly determining the membrane's performance properties.

Suitable coagulants are, for example, liquid water, water vapor and mixtures of water with alcohols, cosolvents, and/or the solvent of the inventive solution, i.e., N-(2′-hydroxyethyl)-2-pyrrolidone. Suitable alcohols are, for example, mono-, di- or trialcohols selected from the group of C₁-C₄ alkanols, C₂-C₈ alkanediols, oligo (alkylene glycol) s, C₃-C₁₂ alkanetriols as they can be used as additives in the inventive solution (see above), or poly(ethylene oxide) with Mₙ of 100 to 1000 g/mol.

Suitable cosolvents are, for example, selected from high-boiling ethers, esters, ketones, asymmetrically halogenated hydrocarbons, anisole, gamma-valerolactone, N,N-dimethylformamide, dimethylsulfoxide, sulfolane, dihydrolevoglucosenone, methyl-5-(dimethylamino)-2-methyl-5-oxopentanoate, N-methyl-2-pyrrolidone, N-ethyl-2-pyrrolidone, N-n-butyl-2-pyrrolidone, N-tert-butyl-2-pyrrolidone, N, N-dimethyl-2-hydroxypropanoic amide, and N, N-diethyl-2-hydroxypropanoic amide. Preferred cosolvents are gamma-valerolactone, N-tert-butyl-2-pyrrolidone, and N-n-butyl-2-pyrrolidone.

Preferably, coagulants are mixtures comprising liquid water and the solvent N-(2′-hydroxyethyl)-2-pyrrolidone or mixtures comprising liquid water and alcohols, e.g., poly(ethylene oxide) with Mₙ of 100 to 1000 g/mol and/or mixtures comprising liquid water and cosolvents. More preferably, coagulants are mixtures comprising liquid water and the solvent N-(2′-hydroxyethyl)-2-pyrrolidone. Said coagulants may comprise from 10 to 90 wt.-% water and 90 to 10 wt.-% alcohol and/or co-solvent(s) or the solvent N-(2′-hydroxyethyl)-2-pyrrolidone, preferably 30 to 70 wt.-% water and 70 to 30 wt.-% alcohol and/or co-solvent(s) or the solvent N-(2′-hydroxyethyl)-2-pyrrolidone, based on the total weight of the coagulant. Generally, the amount of all components of the coagulant add up to 100%.

Further details of process steps a) and b) depend on the desired geometrical structure of the membrane and the scale of production, which includes lab scale or commercial/industrial scale.

In a preferred process, a flat sheet membrane is prepared. This process comprises:
a) Preparing a solution comprising a polyarylsulfone polymer selected from the group of polyethersulfone comprising the repeating unit of formula I and polysulfone comprising the repeating unit of formula II or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer, N-(2′-hydroxyethyl)-2-pyrrolidone, and a water-soluble polymer.
b1) Preparing a polymer film from the solution of step a) by applying the solution of step a) to a substrate
b2) Exposing the polymer film to a coagulant.

### Step a)

The solution of step a) corresponds to a polymer solution as described above. Preferably, the solution further contains additives and/or cosolvents as described above. The preparation of the solution of step a) can be performed as described above.

In a preferred embodiment, the solution of step a) comprises 5 to 45 wt.-% of the polyarylsulfone polymer, 55 to 95 wt.-% of N-(2′-hydroxyethyl)-2-pyrrolidone, and 1 to 15 wt.-% of water-soluble polymer based on the total weight of the solution.

In a more preferred embodiment, the solution of step a) comprises 10-35 wt.-% of the polyarylsulfone polymer, 60 to 90 wt.-% of N-(2′-hydroxyethyl)-2-pyrrolidone and 2 to 10 wt.-% of water-soluble polymer based on the total weight of the solution.

Preferably, the solution is be prepared under stirring at a temperature of 20 to 100° C., preferably 40 to 90° C., more preferably 50 to 70° C. The ready solution typically is degassed for 2 to 24 h, preferably 6 to 20 h, more preferably 10 to 14 h. Subsequently, the solution is preferably re-heated at a temperature of 20 to 100° C., preferably 40 to 90° C., more preferably 50 to 70° C. for 1 to 4 h, preferably 1.5 to 3 h.

### Step b1)

The preparation of a polymer film from the inventive solution can be performed, for example, by casting or other methods like rolling, spraying etc., preferably by casting onto a substrate, preferably, a polymeric substrate (like, e.g., polymer films from biaxially oriented poly(ethylene terephthalate), e.g., under trade name Hostaphan®), a glass substrate, or metal substrates (e.g., metal conveyor belt) using, for example, a casting knife and, optionally, an automated coating machine at a temperature of 40 to 90° C., preferably 50 to 70° C.

In a preferred embodiment, the polymer film is generated by casting, using a casting knife with an aperture of 100 to 500 μm, more preferably of 200 to 400 μm.

### Step b2)

Typically, the polymer film is allowed to rest for 5 to 150 s, preferably 10 to 100 s, more preferably 20 to 60 s and is then subjected to the coagulation bath containing a coagulant as described above. The immersion takes place at 10 to 50° C., preferably 15 to 40° C., more preferably at 20 to 30° C. for 3 to 20 min, preferably 5 to 15 min. Subsequently, the membrane is detached from the substrate and usually subjected to work-up.

In a further preferred process, a non-flat sheet membrane is prepared. This process comprises:
a) Preparing a solution comprising a polyarylsulfone polymer selected from the group of polyethersulfone comprising the repeating unit of formula I and polysulfone comprising the repeating unit of formula II or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer, N-(2′-hydroxyethyl)-2-pyrrolidone, and a water-soluble polymer.
b) Continuous shaping and de-mixing of the solution of step a) to a non-flat geometry by direct exposition of the solution to a coagulant inducing constant solidification of the shaped solution.

### Step a)

The solution of step a) corresponds to a polymer solution as described above. Preferably, the solution further contains additives and/or cosolvents as described above. The preparation of the solution of step a) can be performed as described above.

In a preferred embodiment, the solution of step a) comprises 5 to 45 wt.-% of the polyarylsulfone polymer, 55 to 95 wt.-% of N-(2′-hydroxyethyl)-2-pyrrolidone, and 1 to 15 wt.-% of water-soluble polymer based on the total weight of the solution.

In a more preferred embodiment, the solution of step a) comprises 10-35 wt.-% of the polyarylsulfone polymer, 60 to 90 wt.-% of N-(2′-hydroxyethyl)-2-pyrrolidone, and 2 to 10 wt.-% of water-soluble polymer based on the total weight of the solution.

Preferably, the solution is be prepared under stirring at a temperature of 20 to 100° C., preferably 40 to 90° C., more preferably 50 to 70° C. The ready solution typically is degassed for 2 to 24 h, preferably 6 to 20 h, more preferably 10 to 14 h. Subsequently, the solution is preferably re-heated at a temperature of 20 to 100° C., preferably 40 to 90° C., more preferably 50 to 70° C. for 1 to 4 h, preferably 1.5 to 3 h.

### Step b)

Shaping of the solution of step a) to a non-flat geometry can, for example, be performed via extrusion of the solution through an extrusion nozzle, to get, for example, a fiber-like geometry. To maintain the desired shape, the polymer solution is usually extruded directly into a coagulation bath containing a coagulant as described above, which induces de-mixing of polymer and solvent and thus polymer solidification in the desired shape. If, for example, one or more additional hollow needles are present in the extrusion nozzle, through which additionally a solution of a coagulant is injected to the inside of the developing fibers, single- or multi-tubular geometries are obtained as described in the following.

Preferred membranes showing a non-flat geometry are hollow fiber membranes (single bore hollow fibers or multiple bore hollow fibers). They can be prepared by different spinning technologies, for example by melt spinning, dry spinning or wet spinning. Hereby, the solution obtained in above mentioned step a) is extruded through an extrusion nozzle (also called spinneret) containing the required number of hollow needles (step b). The coagulation liquid is injected through the hollow needles into the extruded polymer during extrusion. By this setup, the extruded polymer membrane gets a hollow cylindrical geometry and parallel continuous channels extending in extrusion direction are formed in the extruded polymer. Preferably, the porous structure on the outer surface of the extruded membrane is formed by bringing the outer surface of the extruded hollow polymer fiber in contact with a mild coagulation agent as for example water vapor such that the shape is fixed without an active layer, i.e., a highly porous filtration layer, on the outer surface. Subsequently, the membrane is brought in contact with a coagulation agent. The parameters of the process, like extrusion speed, temperature, nozzle geometry, type of coagulant, concentrations have an effect on and thus can be used to control pore size and distribution as well as the membrane's shape and thickness and thus the performance of the membrane. Hollow fiber membranes can be optionally wound up onto rolls and/or bundled to bundles of hollow fibers.

The membranes prepared by the procedures described above are usually worked up by washing and/or optional oxidizing steps.

In one embodiment, the membrane prepared by the processes described above (steps a-b) is exposed, after an optional washing step, to a solution containing an oxidatively active component. In this case, the solution containing an oxidatively active component preferably is an aqueous solution. To remove the oxidant, washing is performed after the oxidation step. Preferred is a water-soluble oxidant, such as, e.g., sodium hypochlorite or halogens, especially chlorine in a concentration range of 500 to 5000 wt.-ppm, more preferably from 1000 to 4000 wt.-ppm and particularly preferably from 1500 to 3500 wt.-ppm based on the total weight of the aqueous oxidation solution.

Oxidation as well as washing is performed in order to remove the water-soluble polymer(s) and thus, to form the pores. Oxidation may be followed by washing or vice versa. Oxidation and washing may as well be performed simultaneously in one step. Preferably, the membrane is oxidized with hypochlorite solution or gaseous chlorine at 20 to 90° C., preferably 35 to 80° C., more preferably 50 to 70° C. and at a pH of 9 to 10, preferably 9.3 to 9.7 for 0.5 to 4 h, preferably 1 to 3 h, more preferably 1.5 to 2.5 h, and subsequently washed with water. Washing with water is typically performed in a water bath for 2 to 24 h, preferably for 4 to 20 h, more preferably for 8 to 16 h, and subsequently usually one to five times, preferably three times with water at 20 to 90° C., preferably 35 to 80° C. and more preferably 50 to 70° C. In a further step, the membrane is typically washed with sodium bisulfite solution, preferably using an aqueous sodium bisulfite solution of 0.1 to 1 wt.-%, preferably 0.3 to 0.7 wt.-%, more preferably 0.4 to 0.6 wt.-%.

In case of using the inventive solution based on N-(2′-hydroxyethyl)-2-pyrrolidone for membrane preparation, preferably no oxidative workup is performed. As described above, due to the high viscosities of the inventive solutions, there is no need to use high molecular weight water-soluble polymers to increase the viscosity. Instead of this, low molecular weight water-soluble polymers can be used, which do not require oxidative work-up to be removed.

Moreover, a membrane was found, which is prepared using the inventive solution comprising a polyarylsulfone polymer selected from the group of polyethersulfone comprising the repeating unit of formula I and polysulfone comprising the repeating unit of formula II or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer, N-(2′-hydroxyethyl)-2-pyrrolidone, and a water-soluble polymer.

As described above, the membrane preparation preferably comprises the following steps
a) Preparing a solution comprising a polyarylsulfone polymer selected from the group of polyethersulfone comprising the repeating unit of formula I and polysulfone comprising the repeating unit of formula II or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer, N-(2′-hydroxyethyl)-2-pyrrolidone, and a water-soluble polymer.
b1) Shaping the polymer solution into a certain geometry, like, for example, fiber, tubular or flat sheet geometries, by methods like, for example, extrusion of the polymer solution or preparation of a film from or casting the polymer solution.
b2) Solidifying the geometry shaped in Step b1) by exposing the polymer solution to a coagulant.

Preferably, the solution used for the membrane production further contains additives and/or cosolvents as described above. The preparation of the solution of step a) can be performed as described above. Typically, the membrane is worked up by different washing and/or oxidizing steps as described above.

Beside others, the performance of a membrane can be specified by its pure water permeability (PWP) and its molecular weight cut-off. The PWP reflects the permeability of the membrane towards pure water in dependance on the membrane area, the applied pressure, and time of the permeation experiment according to the following formula (equation 2):

$$PWP = \frac{m}{A \times P \times t} \qquad ( 2 )$$

PWP: pure water permeability [kg/bar h m²]
m: mass of permeated water [kg]
A: membrane area [m²]
P: pressure [bar]
t: time of the permeation experiment [h].

To achieve high flow rates, the membranes according to the invention preferably comprise a high PWP of more than 100 kg/h·m²·bar, more preferably more than 125 kg/h·m²·bar, and particularly preferably more than 150 kg/h·m²·bar for ultrafiltration membranes and preferably more than 25 kg/h·m²·bar, more preferably more than 50 kg/h·m²·bar, and particularly preferably more than 100 kg/h·m²·bar for nanofiltration membranes.

The pure water permeability of the membrane is determined before the determination of its molecular weight cut-off, to avoid limited permeation values due to clogging/fouling of the pores by the polymer used in the molecular weight cut-off determination.

The weight average molecular weight cut-off of the membranes (MWCO) is the molecular weight of the poly(ethylene oxide) standard of the lowest weight-average molecular weight (M_{w}) which is withhold to at least 90% by the membrane. It is usually given in kilo-Daltons (kDa) For example, a MWCO of 18.4 kDa means that poly(ethylene oxide) of M_{w} of 18.4 kDa and higher is withhold to at least 90%. The MWCO of the membranes according to the invention is typically 2-200 kDa, for ultrafiltration membranes, preferably 10-200 kDa, and more preferably 10-100 kDa, and for nanofiltration membranes the upper MWCO limit is typically <10 kDa and the lower MWCO limit is preferably at least 5 kDa, more preferably at least 3 kDa and particularly preferably at least 2 kDa.

The inventive membranes can be used for any kind of separation process of gaseous or liquid mixtures, for example water treatment applications like drinking water purification, treatment of industrial or municipal waste water, desalination of sea or brackish water, dialysis, purification of pharmaceutical products, plasmolysis, and food processing.

In a general embodiment of the inventive process to prepare a flat sheet membrane, polyethersulfone comprising the repeating unit of formula I with a weight average molecular weight of 48000 to 90000 g/mol is mixed with N-(2′-hydroxyethyl)-2-pyrrolidone and polyvinylpyrrolidone showing a K-value of at least 12. The different polymers are used in an amount such that the resulting solution comprises 10 to 35 wt.-% of the polyethersulfone and 2 to 10 wt.-% of polyvinylpyrrolidone. To accelerate the dissolution of the polymers, the mixture is heated under stirring at a temperature of 50 to 70° C. until a homogeneous clear viscous solution is obtained. The solution is then degassed for 10 to 14 h and re-heated at 50 to 70° C. for 1.5 to 3 h. Subsequently, the solution is casted onto a glass plate with a casting knife with an aperture of 200 to 400 μm at a temperature of 50 to 70° C. The resulting film is allowed to rest for 20 to 60 s and then subjected to a water-based coagulation bath comprising 30 to 70 wt.-% water and 70 to 30 wt.-% of N-(2′-hydroxyethyl)-2-pyrrolidone at 20 to 30° C. for 5 to 15 min. After detachment of the glass substrate, the membrane is transferred into a water bath at room temperature, left there for 8 to 16 h, subsequently washed three times with water at 50 to 70° C., and stored in a wet state.

In a general embodiment of the inventive process to prepare a hollow fiber membrane, polysulfone comprising the repeating unit of formula II with a weight average molecular weight of 53000 to 60000 g/mol is mixed with N-(2′-hydroxyethyl)-2-pyrrolidone and poly(ethylene oxide) showing a number average molecular weight Mₙ of at least 250 g/mol. The different polymers are used in an amount such that the resulting solution comprises 10 to 35 wt.-% of the polyethersulfone and 2 to 10 wt.-% of poly(ethylene oxide). To accelerate the dissolution of the polymers, the mixture is heated under stirring at a temperature of 40 to 90° C. until a homogeneous clear viscous solution is obtained. The solution is then degassed for 10 to 14 h, and subsequently re-heated at 40 to 90° C. for 1.5 to 3 h. The solution is then subjected to a wet spinning process at 50 to 70° C., wherein the solution is extruded through an extrusion nozzle (spinneret). The bore fluid, i.e. the above-mentioned coagulation liquid which is injected through the hollow needles into the extruded polymer comprises 20 to 30 vol.-% of water and 70 to 80 vol.-% of the solvent N-(2′-hydroxyethyl)-2-pyrrolidone. The resulting fibers are immersed in a coagulation bath containing water, wound up on a coiler, and subsequently exposed to an aqueous solution comprising 1500 to 3500 wt.-ppm NaOCl at 50 to 70° C. and a pH of 9.3 to 9.7 for 1 to 3 h. Then, the membrane is washed with water at 50 to 70° C. and once with a 0.4 to 0.6 wt.-% aqueous solution of sodium bisulfite. The membrane is stored in a wet state.

It was found that the solvent N-(2′-hydroxyethyl)-2-pyrrolidone readily dissolves polyarylsulfone polymers leading to solutions of low turbidity.

Compared to other solvents, particularly other pyrrolidone derivatives, the utilization of N-(2′-hydroxyethyl)-2-pyrrolidone shows different advantages:

Firstly, N-(2′-hydroxyethyl)-2-pyrrolidone is easily accessible and of low toxicological concern compared, for example, with the frequently used N-methylpyrrolidone.

Secondly, the resulting inventive solutions show high viscosities, which are beneficial for the casting process during membrane preparation by leading to better film quality.

Thirdly, due to the high viscosities of the solution, during membrane preparation there is no need to use high molecular weight water-soluble polymers to increase the viscosity. Instead of this, the high viscosities of the solutions allow for the usage of water-soluble polymers of relatively low K-values or molecular weight values. These kinds of polymers can be removed from the resulting membranes by simple washing with water, without requiring an oxidation step. Thus, advantageously, one process step and thus, the usage of potentially hazardous chemicals (and required further washing steps) can be avoided.

Fourthly, it was found furthermore, that with or without an oxidative work-up, the usage of the inventive solutions containing low molecular weight water-soluble polymers leads to membranes with an advantageous balance of pure water permeability and molecular weight cut-off, and thus to an improved membrane performance compared to membranes known from the art.

### EXAMPLES

Abbreviations and compounds used in the examples:
DMAC N,N-dimethylacetamide
DMSO dimethyl sulfoxide
DSC differential scanning calorimetry
GPC gel permeation chromatography
HEP N-(2′-hydroxyethyl)-2-pyrrolidone
MWCO molecular weight cut-off
NMP N-methyl-2-pyrrolidone
NTU nephelometric turbidity unit
PEO poly(ethylene oxide)
PWP pure water permeation
TBP N-tert.butyl-2-pyrrolidone
2P 2-pyrrolidone
Agnique® AMD 3 L N,N-dimethyl-2-hydroxypropanamide (N, N-dimethyllactamide) abbreviated herein as “AMD3L”
Ultrason® E 3010 Polyethersulfone with a viscosity number (measured based on ISO 1628-5 (1998) in a 1 wt.-% polymer solution in N-methylpyrrolidone) of 66 ml/g; a glass transition temperature (DSC, 10 K/min; according to ISO 11357-1 (2017) and 11357-2 (2020)) of 225° C.; a molecular weight M_{w} (GPC in THF, PS standard) of 58000 g/mol, and M_{w}/Mₙ=3.3, which is abbreviated as “E3010”
Ultrason® E 6020 P Polyethersulfone with a viscosity number (measured based on ISO 1628-5 (1998) in a 1 wt.-% polymer solution in N-methylpyrrolidone) of 81 ml/g; a glass transition temperature (DSC, 10 K/min; according to ISO 11357-1 (2017) and 11357-2 (2020)) of 225° C.; a molecular weight M_{w} (GPC in THF, PS standard) of 75000 g/mol, and M_{w}/Mₙ=3, which is abbreviated as “E6020P”
Ultrason® E 7020 P Polyethersulfone with a viscosity number (measured based on ISO 1628-5 (1998) in a 1 wt.-% polymer solution in N-methylpyrrolidone) of 100 ml/g; a glass transition temperature (DSC, 10 K/min; according to ISO 11357-1 (2017) and 11357-2 (2020)) of 225° C.; a molecular weight M_{w} (GPC in THF, PS standard) of 92000 g/mol, and M_{w}/Mₙ=3.0, which is abbreviated as “E7020P”
Luvitec® K90 Polyvinylpyrrolidone with a molecular weight M_{w} of 1000000 to 1500000 g/mol and a solution viscosity characterized by the K-value of 90, determined according to the method of Fikentscher (Fikentscher, Cellulosechemie 13, 1932 (58)), which is abbreviated as “K90”
Luvitec® K85 Polyvinylpyrrolidone with a molecular weight M_{w} of 1100000 g/mol and a solution viscosity characterized by the K-value of 85, determined according to the method of Fikentscher (Fikentscher, Cellulosechemie 13, 1932 (58)), which is abbreviated as “K85”
Luvitec® K30 Polyvinylpyrrolidone with a molecular weight M_{w} of 44000 to 540000 g/mol and a solution viscosity characterized by the K-value of 30, determined according to the method of Fikentscher (Fikentscher, Cellulosechemie 13, 1932 (58)), which is abbreviated as “K30”
Luvitec® K25 Polyvinylpyrrolidone with a molecular weight M_{w} of 28000 to 340000 g/mol and a solution viscosity characterized by the K-value of 25, determined according to the method of Fikentscher (Fikentscher, Cellulosechemie 13, 1932 (58)), which is abbreviated as “K25”
Luvitec® K17 Polyvinylpyrrolidone with a molecular weight M_{w} of 7000 to 11000 g/mol and a solution viscosity characterized by the K-value of 17, determined according to the method of Fikentscher (Fikentscher, Cellulosechemie 13, 1932 (58)), which is abbreviated as “K17”
Luvitec® K12 Polyvinylpyrrolidone with a molecular weight M_{w} of 2000 to 3000 g/mol and a solution viscosity characterized by the K-value of 12, determined according to the method of Fikentscher (Fikentscher, Cellulosechemie 13, 1932 (58)), which is abbreviated as “K12”
Pluriol® E 400 Poly(ethylene oxide) with a number average molecular weight Mₙ of 400 g/mol calculated from the OH numbers according to DIN 53240, which is abbreviated as “PEO 400”

### Determination of Solution Turbidity

The polymer solution turbidity was measured with a turbidimeter 2100AN (Hach Lange GmbH, Düsseldorf, Germany) employing a filter of 860 nm at 60° C. and expressed in nephelometric turbidity units (NTU).

### Determination of Solution Viscosity

The polymer solution viscosity was measured with a Brookfield Viscometer DV-I Prime (Brookfield Engineering Laboratories, Inc. Middleboro, USA) with RV 6 spindle at 60° C. with 5-100 rpm. The utilized shear rate is dependent on the solution viscosity and is given in the tables below.

### Determination of the Membrane Water Permeability

The pure water permeability (PWP) of the membranes was tested using a pressure cell with a diameter of 74 mm using ultrapure water (salt-free water, filtered by a Millipore UF-system) at 23° C. and 1 bar water pressure. The pure water permeability (PWP) is calculated as follows (equation 2):

$$PWP = \frac{m}{A \times P \times t} \qquad ( 2 )$$

PWP: pure water permeability [kg/bar h m²]
m: mass of permeated water [kg]
A: membrane area [m²]
P: pressure [bar]
t: time of the permeation experiment [h].

### Determination of the Membrane's MWCO

In a subsequent test, solutions of poly(ethylene oxide)-standards with increasing molecular weight were used as feed to be filtered by the membrane at a pressure of 0.15 bar. By GPC-measurement of the feed and permeate, the molecular weight of the permeate of each poly(ethylene oxide)-standard used was determined.

### Examples 1-17: Viscosity and Turbidity of Polyarylsulfone Polymer Solutions in Different Solvents

Inventive polymer solutions using different polyarylsulfone polymers at a given concentration of 20 wt.-% were prepared using a SpeedMixer® DAC 600.1 Vac-P (Hauschild & Co. KG, Hamm, Germany) at speeds of 200, 800 and 1200 rpm within 30 minutes of mixing. For comparison, corresponding solutions were prepared using other solvents according the same procedure. The solution viscosity and turbidity was measured at 60° C. according to the procedures described above. The results are summarized in table 1.

TABLE 1
Viscosity and turbidity of 20 wt.-% polymer solutions at 60° C.

| | Polymer | | Viscosity | | Turbidity |
|---|---|---|---|---|---|
| | type | Solvent | [Pa · s] (rpm) | | [NTU] |
| example 1 | E3010 | HEP | 18 | (20) | 0.51 |
| comp. example 2 | E3010 | AMD3L | 1.4 | (100) | 0.81 |
| comp. example 3 | E3010 | NMP | 0.42 | (100) | 0.38 |
| comp. example 4 | E3010 | TBP | 1.2 | (100) | 0.71 |
| comp. example 5 | E3010 | 2P | 3.95 | (100) | 0.63 |
| example 6 | E6020P | HEP | 47 | (20) | 0.65 |
| comp. example 7 | E6020P | AMD3L | 3.3 | (100) | 0.87 |
| comp. example 8 | E6020P | NMP | 0.84 | (100) | 0.49 |
| comp. example 9 | E6020P | TBP | 2.9 | (100) | 0.78 |
| comp. example 10 | E6020P | 2P | 8.55 | (20) | 0.75 |
| comp. example 11 | E6020P | DMAc | 0.35 | (100) | 1.64 |
| comp. example 12 | E6020P | DMSO | 1.30 | (100) | 0.76 |
| example 13 | E7020P | HEP | 136 | (5) | 0.54 |
| comp. example 14 | E7020P | AMD3L | 8.6 | (100) | 0.82 |
| comp. example 15 | E7020P | NMP | 2.3 | (100) | 0.46 |
| comp. example 16 | E7020P | TBP | 8.1 | (100) | 0.81 |
| comp. example 17 | E7020P | 2P | 24.6 | (20) | 0.94 |

The data summarized in table 1 shows that at a given concentration of polyarylsulfone polymer, the inventive solutions using N-(2′-hydroxyethyl)-2-pyrrolidone as solvent show significantly higher viscosity levels compared to the corresponding solutions based on other solvents (comparative examples). This remains valid also if the type of polyarylsulfone polymer is changed. A higher solution viscosity is advantageous, because it facilitates the process step of film casting resulting in better films. Furthermore, the solution turbidities of the inventive solutions are on a low level which is required to get high quality membranes. Higher turbidity levels could cause defects in the membranes and thus lower their separation performance. The turbidities are on similar levels compared to solutions based on other solvents (comparative examples).

### Preparation of Membranes—General Procedure

The amounts given in this general procedure are general ranges, the exact amount for the respective experiment can be found in tables 2 and 4-7. Into a three-neck flask equipped with a magnetic stirrer there were added 65 or 81 g of solvent, 15 to 19 g Ultrason® polymer, 4 to 8 g Luvitec® polyvinylpyrrolidone or poly(alkylene oxide) (e.g., Pluriol® E 400) as given in tables 2 and 4-7. The mixture was heated under gentle stirring at 60° C. until a homogeneous clear viscous solution, usually referred to as solution was obtained. The solution was degassed overnight at room temperature.

After that, the membrane solution was reheated at 60° C. for 2 hours and casted onto a glass plate with a casting knife (300 microns) at 60° C. using an Erichsen Coating machine (Coatmaster 510, Erichsen GmbH & Co KG, Hemer, Germany) operating at a speed of 5 mm/s. The membrane film was allowed to rest for 30 seconds before immersion at 25° C. for 10 minutes in a water-based coagulation bath consisting of a mixture of the same solvent used for the preparation of the above-mentioned polymer solution and water at a ratio of 40:60 based on weight. After the membrane had detached from the glass plate, the membrane was exposed to either posttreatment A or posttreatment B.

### Posttreatment A (No Oxidizing Step, Only Washing)

The membrane was washed with water at 60° C. three times.

### Optional Posttreatment B (Oxidizing and Washing Step)

The membrane was transferred into a water bath containing a 2000 ppm NaOCl solution at 60° C. and a pH of 9.5 for 2 h. The membrane was then washed with water at 60° C. and one time with a 0.5 wt.-% solution of sodium bisulfite to remove active chlorine.

After the posttreatment the membranes are stored in a wet state.

### Examples 18-20: Solutions with Adjusted Viscosity and Membranes Thereof with and without Oxidative Workup

The inventive polymer solution as well as comparative polymer solutions were prepared according to the above-mentioned procedure using polymer types and amounts of polymers as given in table 2. The amount of the water-soluble polymers was kept constant. The type of water-soluble polymer was selected such, that the ready solution showed a target viscosity of 16-17 Pa·s.

The viscosity and turbidity was measured according to the above-mentioned methods. From every of these solutions two membranes were prepared in each case, according to the procedure described above including in one case only washing with water as workup (posttreatment A) and in the other case oxidative workup with NaOCl and washing with sodium bisulfite solution (posttreatment B). For every membrane, pure water permeability and molecular weight cut-off was determined as to the above-mentioned methods. The results are summarized in Table 3.

TABLE 2
Solutions of Ultrason ® E 6020 P in different solvents
and in combination with different water-soluble polymers. All
solutions are adjusted to a viscosity of 16 to 17 Pa · s at 20 rpm.

| | E6020P | K17 | K25 | K30 | K85 | K90 | HEP | AMD3L | 2P |
|---|---|---|---|---|---|---|---|---|---|
| example 18 | 15 g | 5 g | — | — | — | — | 80 g | — | — |
| comp. example 19 | 15 g | — | — | — | 5 g | — | — | 80 g | — |
| comp. example 20 | 15 g | — | — | 2.5 g | — | 2.5 g | — | — | 80 g |

TABLE 3
Solutions of Ultrason ® E 6020 P in different solvents and in combination with different water-
soluble polymers - Solution properties and performance of resulting membranes without or with oxidative workup.

| | | | | PWP 1 | MWCO 1 | PWP 2 | MWCO 2 |
|---|---|---|---|---|---|---|---|
| | | Viscosity | Turbidity | [kg/h m²bar] | [kDa] | [kg/h m²bar] | [kDa] |
| | Solvent | [Pa · s] at 20 rpm | [NTU] | Posttreatment A | | Posttreatment B | |
| example 18 | HEP | 16.0 | 0.49 | 560 | 9.5 | 710 | 14.4 |
| comp. example 19 | AMD3L | 16.6 | 0.87 | 190 | 18.9 | 1070 | 76.4 |
| comp. example 20 | 2P | 16.9 | 0.52 | 340 | 21.0 | 1050 | 76.4 |

These experiments show, that with a given amount of water-soluble polymer, in case of the inventive solution comprising the polyarylsulfone polymer Ultrason® E 6020 P and N-(2′-hydroxyethyl)-2-pyrrolidone, a water-soluble polymer having a lower K-value (according to Fikentscher, see above) leads to the target solution viscosity, whereas in case of the other solvents, water-soluble polymers of higher K-values are needed. This is due to the higher viscosity contribution of the inventive solvent N-(2′-hydroxyethyl)-2-pyrrolidone. Since the K-value is a measure for molar mass, this means, that solvents other than N-(2′-hydroxyethyl)-2-pyrrolidone need water-soluble polymers of higher molar mass to get the same target viscosity. A certain viscosity level is needed to get high quality films by casting.

A further advantage in case of N-(2′-hydroxyethyl)-2-pyrrolidone results from the fact that the lower molecular weight water-soluble polymers can be removed from the resulting membranes by simple washing with water. An oxidative work-up is not necessary in this case, whereas in case of the other solvents, the higher molecular weight water-soluble polymers can only be removed significantly, if an oxidative work-up is performed. In case of N-(2′-hydroxyethyl)-2-pyrrolidone, resulting membranes show higher pure water permeability combined with lower molecular weight cut-offs, even if no oxidative work-up is performed, whereas the membranes resulting from the other solutions show lower PWP and higher MWCO. In the case of other solvents, oxidative work-up leads to higher PWP but at the same time significantly higher MWCO.

### Examples 21-48: Solutions with Different Water-Soluble Polymers and Membranes Thereof without Oxidative Workup

Different membranes were prepared according to the above-mentioned procedure. In doing so, different water-soluble polymers, i.e., different polyvinylpyrrolidone grades or poly(ethylene oxide) (PEO 400) was used. The viscosity and turbidity of the polymer solution before the casting step was determined according to the above-mentioned procedures. Work-up of the membranes was done only by washing with water (posttreatment A). PWP and MWCO of the resulting membranes were analyzed according to the methods described above. The results are summarized in table 4-7.

TABLE 4
Compositions and properties of Ultrason ®
E 3010 membranes prepared with K12 and PEO 400

| | | | | | Viscosity | | PWP | |
|---|---|---|---|---|---|---|---|---|
| | | | PEO | | [Pa · s] | Turbidity | [kg/h | MWCO |
| | E3010 | K12 | 400 | Solvent | (rpm) | [NTU] | m²bar] | [kDa] |
| example 21 | 19 g | 6 g | — | 65 g HEP | 23.4 (20) | 0.50 | 220 | 2.9 |
| example 22 | 19 g | — | 6 g | 65 g HEP | 12.7 (20) | 0.57 | 190 | 3.6 |
| comp. example 23 | 19 g | 6 g | — | 65 g NMP | 0.49 (100) | 0.38 | 0 | — |
| comp. example 24 | 19 g | — | 6 g | 65 g NMP | 0.39 (100) | 0.44 | 0 | — |

TABLE 5
Compositions and properties of Ultrason ® E 3010 membranes prepared with K12

| | | | | Viscosity | Turbidity | PWP | MWCO |
|---|---|---|---|---|---|---|---|
| | E3010 | K12 | Solvent | [Pa · s] (rpm) | [NTU] | [kg/h m²bar] | [kDa] |
| example 25 | 17 g | 6 g | 77 g HEP | 11.1 (20) | 0.61 | 410 | 5.9 |
| example 26 | 15 g | 6 g | 79 g HEP | 6.8 (20) | 0.62 | 630 | 9.1 |
| example 27 | 15 g | 4 g | 81 g HEP | 4.9 (20) | 0.74 | 690 | 7.9 |
| example 28 | 15 g | 8 g | 77 g HEP | 8.2 (20) | 0.61 | 590 | 9.8 |
| comp. example 29 | 17 g | 6 g | 77 g NMP | 0.28 (100) | 0.40 | 5 | — |
| comp. example 30 | 15 g | 6 g | 79 g NMP | 0.15 (100) | 0.40 | 6 | — |
| comp. example 31 | 15 g | 4 g | 81 g NMP | 0.13 (100) | 0.40 | 2 | — |
| comp. example 32 | 15 g | 8 g | 77 g NMP | 0.19 (100) | 0.42 | 2 | — |

TABLE 6
Compositions and properties of Ultrason ® E 3010 membranes prepared with K25

| | | | | Viscosity | Turbidity | PWP | MWCO |
|---|---|---|---|---|---|---|---|
| | E3010 | K25 | Solvent | [Pa · s] (rpm) | [NTU] | [kg/h m²bar] | [kDa] |
| example 33 | 17 g | 6 g | 77 g HEP | 20.8 (20) | 0.64 | 300 | 12.2 |
| example 34 | 15 g | 6 g | 79 g HEP | 10.7 (20) | 0.61 | 400 | 20.4 |
| example 35 | 15 g | 4 g | 81 g HEP | 7.9 (20) | 0.65 | 470 | 15.1 |
| example 36 | 15 g | 8 g | 77 g HEP | 8.3 (20) | 0.85 | 260 | 13.4 |
| comp. example 37 | 17 g | 6 g | 77 g NMP | 0.4 (100) | 0.46 | 6 | — |
| comp. example 38 | 15 g | 6 g | 79 g NMP | 0.24 (100) | 0.46 | 10 | — |
| comp. example 39 | 15 g | 4 g | 81 g NMP | 0.16 (100) | 0.48 | 19 | — |
| comp. example 40 | 15 g | 8 g | 77 g NMP | 0.34 (100) | 0.53 | 25.5 | — |

TABLE 7
Compositions and properties of Ultrason ® E 3010 membranes prepared with K30

| | | | | Viscosity | Turbidity | PWP | MWCO |
|---|---|---|---|---|---|---|---|
| | E3010 | K30 | Solvent | [Pa · s] (rpm) | [NTU] | [kg/h m²bar] | [kDa] |
| example 41 | 17 g | 6 g | 77 g HEP | 23.1 (20) | 0.64 | 270 | 11.7 |
| example 42 | 15 g | 6 g | 79 g HEP | 13.0 (20) | 0.67 | 390 | 18.8 |
| example 43 | 15 g | 4 g | 81 g HEP | 8.8 (20) | 0.74 | 520 | 19.7 |
| example 44 | 15 g | 8 g | 77 g HEP | 20.5 (20) | 0.68 | 235 | 15.5 |
| comp. example 45 | 17 g | 6 g | 77 g NMP | 0.5 (100) | 0.56 | 12 | — |
| comp. example 46 | 15 g | 6 g | 79 g NMP | 0.3 (100) | 0.52 | 12 | — |
| comp. example 47 | 15 g | 4 g | 81 g NMP | 0.2 (100) | 0.49 | 17 | — |
| comp. example 48 | 15 g | 8 g | 77 g NMP | 0.4 (100) | 0.52 | 40 | — |

Table 4-7 show that the inventive solutions based on N-(2′-hydroxyethyl)-2-pyrrolidone show higher solution viscosities compared to corresponding NMP-solutions. Thus, the inventive solutions are better suited for casting films. If the resulting membranes are not worked-up oxidatively but only by washing with water, in case of N-(2′-hydroxyethyl)-2-pyrrolidone the resulting membranes show an advantageous balance of PWP and MWCO, whereas in the case of NMP extremely low PWP values occur, which are not suitable for effective separation procedures

1.-15. (canceled)

16. A solution comprising:
(a) a polyarylsulfone polymer selected from the group of polyethersulfone comprising repeating units of formula I 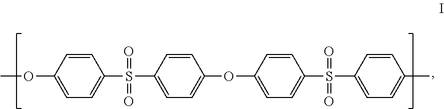
and polysulfone comprising repeating units of formula II 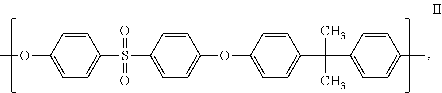
or mixtures thereof, wherein the weight average molecular weight M_{w} of the polyarylsulfone polymer is in the range from 40000 to 105000 g/mol and the polyarylsulfone polymer comprises at least 95 wt.-% of the repeating units of formula I and II based on the total weight of the polyarylsulfone polymer,
and
(b) N-(2′-hydroxyethyl)-2-pyrrolidone.

17. The solution according to claim 16, wherein the solution comprises 50 to 99 wt.-% of N-(2′-hydroxyethyl)-2-pyrrolidone based on the total weight of the solution.

18. The solution according to claim 16, wherein the solution comprises 1 to 50 wt.-% of polyarylsulfone polymer based on the total weight of the solution.

19. The solution according to claim 16, comprising a water-soluble polymer showing a solubility in water at 21° C. of at least 10 g per 100 g water.

20. The solution according to claim 19, wherein the solution comprises 0.1 to 15 wt.-% of a water-soluble polymer based on the total weight of the solution.

21. The solution according to claim 19, wherein the water soluble polymer is selected from polyvinylpyrrolidone, poly(alkylene glycol) or mixtures thereof.

22. The solution according to claim 16, comprising an additive, in which the polyarylsulfone polymer is soluble at 21° C. at concentrations of <1 g polyarylsulfone polymer per 100 g additive.

23. The solution according to claim 22, wherein the solution comprises 0.1 to 20 wt.-% of the additive based on the total weight of the solution.

24. The solution according to claim 22, wherein the additive is selected from the group of: water, C₁-C₄ alkanols, C₂-C₈ alkandiols, oligo (alkylene glycol)s, and C₃-C₁₂ alkantriols or mixtures thereof.

25. The solution according to claim 16, showing a solution viscosity of 4 to 150 Pa·s as determined with a Brookfield Viscometer DV-I Prime with RV 6 spindle at 60° C. and 5-100 rpm (rounds per minute).

26. The solution according to claim 16, showing a solution turbidity of 0 to 1 NTU (nephelometric turbidity unit) as determined with a turbidimeter employing a filter of 860 nm at 60° C.

27. A process for the preparation of a membrane using the solution according to claim 19.

28. The process for preparing a membrane using the solution according to claim 19 comprising the following steps:
a) preparing a solution according to claim 19,
b1) preparing a polymer film from the solution of step a) by applying the solution of step a) to a substrate, and
b2) exposing the polymer film to a coagulant.

29. The process for preparing a membrane using the solution according to claim 19 comprising the following steps:
a) preparing a solution according to claim 19, and
b) continuous shaping and de-mixing of the solution of step a) to a non-flat geometry by direct exposition of the solution to a coagulant inducing constant solidification of the shaped solution.

30. A method comprising utilizing the membranes according to claim 27 in drinking water purification, treatment of industrial or municipal waste water, desalination of sea or brackish water, dialysis, purification of pharmaceutical products, plasmolysis or food processing.
